(19) United States
(12) Patent Application Publication
(10) Pub. No.: US 2010/0005714 A1
(43) Pub. Date: Jan. 14, 2010

(54) PLANT SUPPORT POLE AND METHOD OF USE

(76) Inventor: JOHN E. AIKEN, Monroeville, PA (US)

Correspondence Address: James Ray & Associates, 2640 Pitcairn Road, Monroeville, PA, 15146, US

(21) Appl. No.: 12/500,636

(22) Filed: Jul. 10, 2009

Related U.S. Application Data
(60) Provisional application No. 61/134,482, filed on Jul. 10, 2008.

(51) Int. Cl. A01G 17/14; A01G 17/04

(52) U.S. Cl. 47/47; 47/44

(57) ABSTRACT

An apparatus for supporting plants growing from the ground includes an elongated rigid pole with a plurality of axially-spaced apertures along much of the pole. Flexible cord ties are threaded in a spiral fashion through at least three apertures in the long wall of the elongated pole, and knots at the ends are tied around plant stems or branches thereby preventing disengagement from the holes and simultaneously supporting the plant. One end of the elongated pole is cut at an angle to the axis to form a point.

### CROSS REFERENCE TO RELATED APPLICATION

This patent application is related to and claims priority from U.S. Provisional Patent Application Ser. No. 61/134,482 filed Jul. 10, 2008.

### FIELD OF THE INVENTION

The present invention relates, in general, to devices for supporting plants and, more particularly, this invention relates to inexpensive reusable poles for supporting tomato and other garden plants.

### BACKGROUND OF THE INVENTION

Prior to the conception and development of the present invention, home gardeners have been using various means for keeping most of their tomato plants off the ground while growing and particularly when the tomatoes begin appearing on the plants. This helps the plants to grow, but mostly it guards against the vegetable resting on the ground and rotting or getting infested with insects. For many decades, wooden stakes have been driven in along side each plant, and then rope, twine, or cloth strips are used to try to hold the plant stems near the stake and away from the ground. The ties tend to slide down the stakes and the stakes and ties are prone to rotting. Wire cages have been popular in recent years for supporting tomato plants. There are usually at least 3 wire legs to push into the ground, and one of these typically will hit a stone and bend. The cages are generally too short, prone to bending and rusting, and also tend to tip over. A vinyl coated triangular shaped cage has come on the market, but the legs still are susceptible to rust and bending. All of the cage types suffer from the problem of some plant branches draping over the first rung and then hanging back down to the ground. Efforts to place the branches back into the cage sometimes cause the branches to break. Also, the cages are difficult to install without breaking branches once the plant has grown considerably.

Various prior art has disclosed efforts to improve on plant stakes. For instance, Ford in U.S. Pat. No. 904,769 discloses a wire plant support stake with integral coils or loops along the length for attachment of tie cords. Besides being subject to getting rusted and bent at or below grade, this design would be susceptible to bending over or coming out of the ground the taller it gets. Also, one needs to provide cord of the appropriate length and then tie the plant to the stake coils.

U.S. Pat. No. 2,862,334 discloses a system for supporting plant branches only with special strings and hooks attached to a special top ring on a pole. The main stem itself is not directly supported, and the fragile branches must do all the supporting. For a tall stake or pole, this design would not be practical. U.S. Pat. No. 2,851,823 discloses an adjustable plant support system of horizontal hoops that engage with brackets that can be adjusted for height along the stake. The hoops are of a fixed size, thus they may not extend out far enough in some cases, but if too large branches laden with tomatoes may drop down through.

Numerous U.S. patents have disclosed various devices for supporting plants while also providing a way to water and feed the plants. U.S. Pat. No. 2,809,468 discloses a combination stake and feeder, primarily for potted plants. A hollow tube connects at the top to a funnel which can also be used to add on an extension tube. Straps with slots attach to special extensions on the lip of the funnel to help support a portion of the plant. There can be only one strap per section, thus support is limited and side branches would likely go unsupported.

U.S. Pat. No. 3,345,774 discloses a rather involved apparatus for watering and feeding plants with provisions for tying up plants. The stake has very thick walls, and tangential or peripheral holes are drilled through the thick walls to accommodate rods or cords for holding up plants. U.S. Pat. No. 5,067,274 discloses a tomato plant irrigation and support pole utilizing a hollow pole with multiple V-shaped notches along the length. Cross member rods slip into the notches and plant stems can then be tied to the rods. Gardeners wanting a dozen of these support poles are likely to find the cost to be considerable due to the complexity of construction. A somewhat similar design is disclosed in U.S. Pat. No. 5,901,497. A hollow tube has an integral funnel at the top, and L-shaped branches extend out horizontally in two directions from holes spaced along much of the tube. U.S. Pat. No. 4,745,706 discloses a plant watering and feeding stake that has snap-on plastic straps that can slide up and down the stake. However, the support range is not very far from the stake. There are numerous other such prior art devices with the disadvantage of having to pull plant stems and branches up very close to the stake, which risks breakage and may bunch plant stems in an unnatural and crowded position.

U.S. Pat. No. 4,021,965 discloses a fertilizer dispensing stake that has integral plant ties along much of the height. However, the stake is actually a series of stacked individual compartments that can be loaded with fertilizer. Holes in the hollow stake allow for gradual release of the fertilizer or pesticide in the compartments. Plant ties are located only at the joints between compartment, so the number and support locations are limited. Fabrication of these appears to be involved and relatively expensive.

U.S. Pat. No. 5,542,210 discloses a plastic plant support stake with slots through the wall along the length. Straps are placed through the slots to clamp around a portion of a plant to be supported. As with nearly all prior art, the plant must be pulled up close to the stake, and the stake is not extendable above an average person's height.

U.S. Pat. No. 7,219,467 discloses a plant support system that utilizes multiple legs that then have a cord member spirally strung through apertures molded into the special leg members. The cord or twine typically surrounds the plant. The support system of the '467 patent requires specially fabricated leg members which will add considerably to the cost. Also, it would provide no aid in the watering or fertilizing of the plant. A common shortcoming of all the aforementioned prior art is that there is no consideration given to growing plants to a height taller than a typical person. One may say it would be obvious to just scale some of these up to whatever height is desired, but then it generally will be necessary to use a ladder to install and tie plants near the top. This poses an inconvenience and a safety hazard, especially on sloped ground. Also, the cost for some designs would make them impractical.

Commercially available plant supports of all sorts abound. The spiral stake is one example of a more recent offering, but it offers no ties that are prevented from slipping down under the weight of tomatoes. Another is the tomato ladder, which is a steel three-pole cage available from gardeners.com. It can be extended to an installed height of 77 inches, but total cost is relatively high to get there. Also, there is no way to deal with plant branches that grow through a window then droop toward the ground. Preventing the plants from slumping or sliding down under the weight of the tomatoes is a common problem, and not adequately addressed by most of the prior art. There is still a need for an economical apparatus that can support to 7 feet or higher without the need for a ladder.

### SUMMARY OF THE INVENTION

An apparatus for supporting plants growing from the ground includes an elongated rigid pole with a plurality of axially-spaced apertures. Flexible cords are threaded through at least three apertures axially spaced along much of the length of the pole, and knots in the ends or around plant stems readily prevent disengagement from the holes. One end of the elongated pole is cut at an angle to the axis to form a point.

In a preferred embodiment of the present invention, a removable extension member creates a taller pole after installation in the ground. The pole and extension member are rigid PVC tubes. Various alternative coupling means for the extension member are taught.

### OBJECTS OF THE INVENTION

It is, therefore, one of the primary objects of the present invention to provide a durable, reusable, yet inexpensive and effective plant support pole or stake.

Another object of the present invention is to provide a tall tomato pole with included attachments for supporting plants along the entire height.

Still another object of the present invention is to provide a ready-to-use tomato stake with multiple plant support means over a long length allowing adjustable support of plant stems and branches at varying heights and horizontal distances from the stake.

Yet another object of the present invention is to provide an inexpensive, effective plant support system that can support to heights above 7 feet without the need of a ladder to install and use.

An additional object of the present invention is to provide a lightweight inexpensive tomato stake resistant to all kinds of decay and corrosion and hence reusable for many years.

Another object of the present invention is to provide a plant support system which is extendable in length by a slip fit tubular attachment.

Yet still another object of the present invention is to provide a plant support pole which is easy to remove and store for the next the season.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is an elevation perspective view of the present invention.

FIG. 2 presents an elevation perspective view of an alternative embodiment of the present invention.

FIG. 3 is an elevation view of a preferred extended embodiment of the present invention.

FIG. 4 provides perspective views of various means for securing the ends of the cord ties.

FIG. 5 provides an elevation view of the present invention with a plant illustrating support ways achievable with the present invention.

FIG. 6 presents an elevation perspective view of an alternative embodiment of the present invention.

FIG. 7 provides a detail elevation perspective view of an alternative embodiment of the present invention.

FIG. 8 provides a partial elevation perspective view of an alternative coupling means for the extension member.

FIG. 9 provides a partial elevation perspective view of another alternative coupling means for the extension member.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

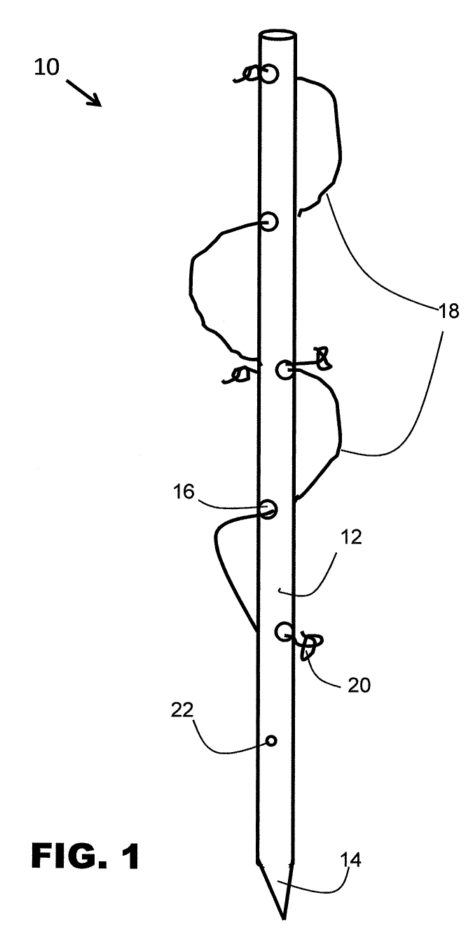

Referring initially to FIG. 1, an elevation perspective view of the present invention, generally shown as 10, is provided. An elongated pole 12 has been cut at an angle on one end to form a point 14. Preferably, but optionally, the pole 12 is a hollow tube, and the cross sectional shape may be circular, square, or one of many others. Apertures 16 about ¼-inch to ½-inch in diameter, or equivalent diameter if non circular, have been bored through at four or more locations along the length. A preferred spacing is about 6 to 10 inches. The apertures can be in various shapes, but the minimum dimension needs to be 0.15-inch to allow passage of the cord tie. The apertures are preferably opposing pairs with one through one wall of the elongated tube 12, and the other half of the pair substantially 180 degrees from an opposing aperture in another portion of the cylinder wall at approximately the same height. If a straight rod is put through the pair of opposing apertures, it will pass essentially through the central axis of the pole, hence these apertures are generally referred to herein as “radial” apertures. The elongated tubular pole 12 is typically a section of rigid PVC pipe or conduit about 5 to 7 feet in length and one-half to 1.5 inches in outside diameter. Especially preferred is nominal ¾-inch schedule 40 rigid PVC conduit tubing. The elongated tubes (poles) 12 may also be made of other plastic, metal, vinyl coated metal, or wood. While it is preferable that it be hollow, it need not be. The elongated poles 12 also are preferably colored or tinted with a pigment melt-blended into the PVC tubing during manufacture. Two or more flexible laces or cord ties 18 of a minimum length of 15 inches are threaded through three or more apertures 16 and are initially terminated generally with a single knot 20. Preferably, cord ties 18 are between about 36 and 48 inches long. Optional weep holes 22 can be added near the expected ground level to aid in watering or fertilizing the adjacent plant.

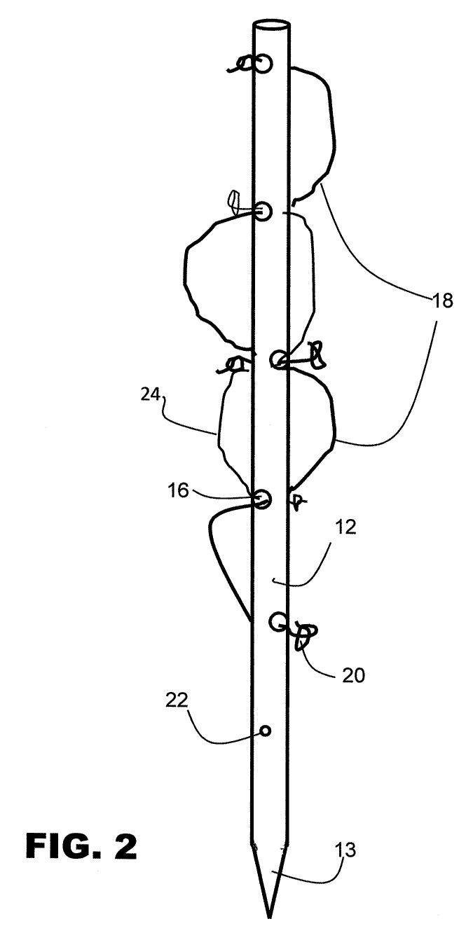

FIG. 2 provides a similar elevation view with two variations. The point 13 could be, but preferably is not, a single-cut beveled end, but instead a double-cut point with two cuts tapered generally to the center axis. Surprisingly, the single cut beveled ends makes it difficult to pound the poles straight into the ground, but the double cut works well. In certain zones along the length of elongated pole 12, there optionally is a second course of cord ties 24 to augment the other cord ties 18. These are typically in the more central area to provide more support capability where there are often multiple branches to support. The cord ties or laces 18 and 24 are preferably 15 to 60-inch pieces of a vinyl (PVC) clothesline, and when apertures 16 are about ⅜-inch to ½-inch diameter, there is ample room to easily feed through two cord ties 18. The cord ties 18 could also be an elastic material or any of several other materials typically fashioned into strings, shoe laces, or cords. The flexible PVC type is preferred because of the advantages of not fraying, being gentle with the plant stems, and the ability of a single-loop knot to hold for several months.

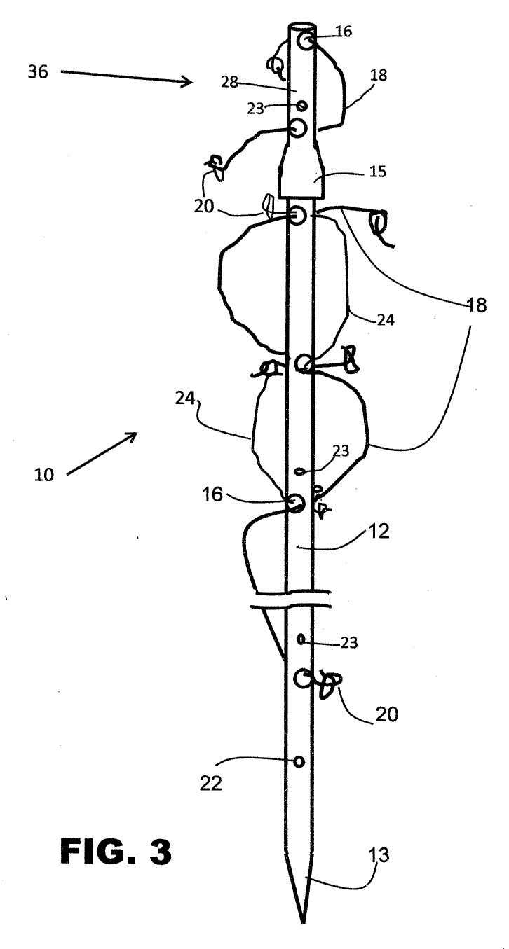

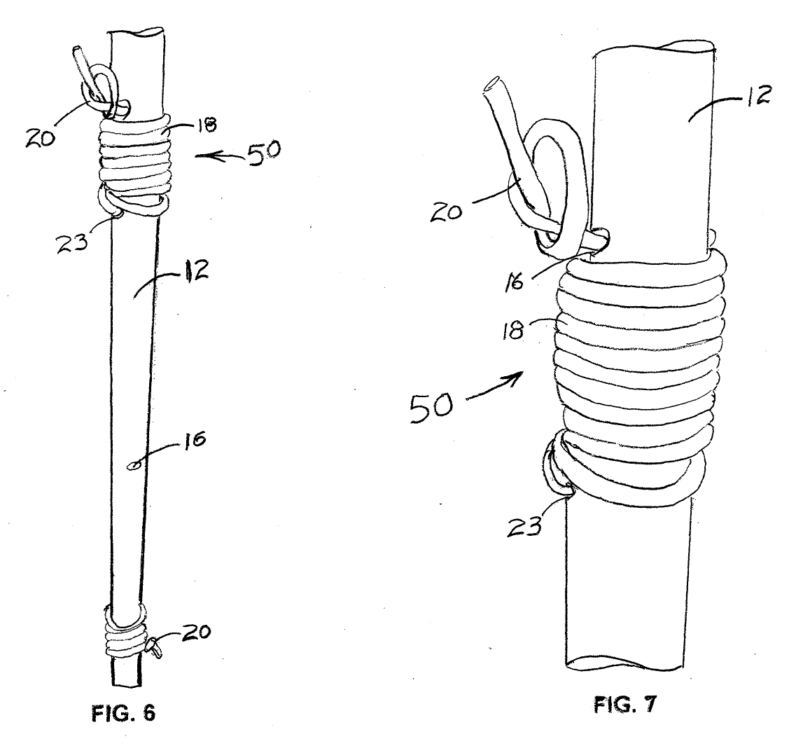

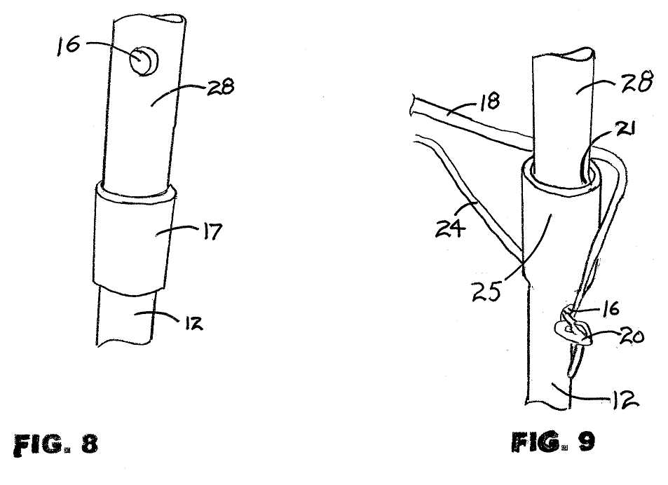

FIG. 3 provides an elevation view of a preferred embodiment of the present invention made taller by adding a vertical extension member 36 to the top of the elongated tube 12. Otherwise, the elements of the bottom section of plant support apparatus 10 remain essentially the same, except that now practical lengths are between about 3 and 7 feet since it is extendable. The extension tube 28 is typically, but optionally, the same diameter as the elongated tube 12, and is 30 to 48 inches long and is removably attached to the top of the elongated pole 12 along the same axis with a coupling means 15. Preferably this coupling means 15 is an integral flared end on either the pole 12 or the extension tube 28. The flared end 15 is shown on the extension tube 15 in FIG. 3. However, it may also be a female slip-fit coupling (FIG. 8) or a threaded connector. The extension tube 28 will also have at least two pairs of opposing wall apertures 16. Preferably, but optionally, two or more cord-retention apertures 23, slightly greater in diameter than the cord ties 18, are in the wall of the pole 12 for tucking in cord ends during transport or storage, as illustrated in more detail in FIG. 6 and FIG. 7. Preferably, but optionally, there is also at least one cord-retention aperture 23 in the wall of the extension tube 28. The extension member 36 also includes at least one lacing cord tie 18 of at least 18 inches in length, and typically no more than 48 inches.

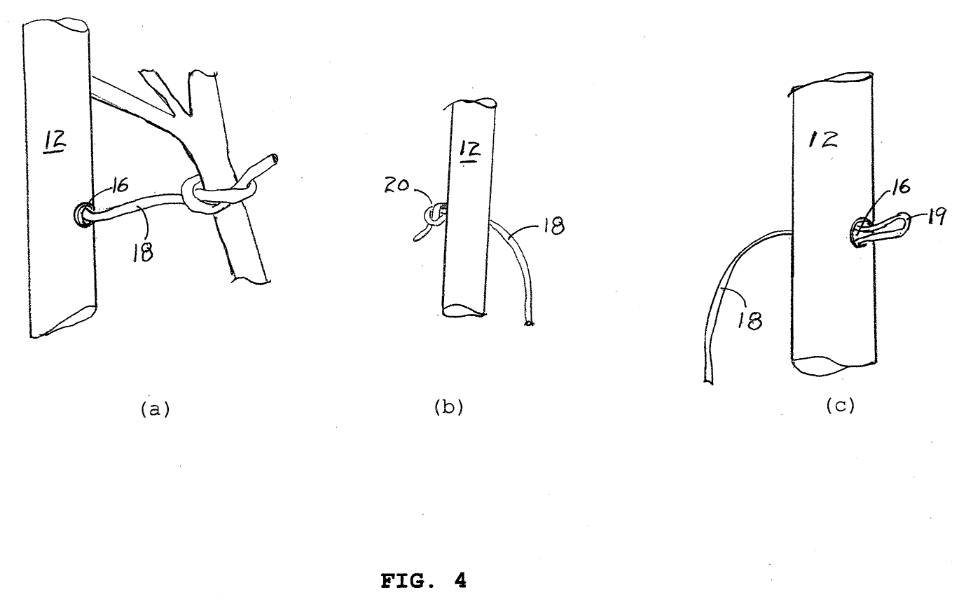

FIG. 4 provides three partial detail views of various ways to terminate or tie off the ends of cord ties 18. Where circumstances permit, FIG. 4(a) shows the preferred method as the knot 20 serves the dual purpose of supporting the plant stem or branch and also retaining the end of cord tie 18 from slipping through the aperture 16. In FIG. 4(b), a knot 20 is tied in cord 18 after it has been threaded through the pair of apertures 16 in the elongated tube 12. In FIG. 4(c), the end of cord 18 is doubled back into aperture 16 to form a loop 19. With vinyl clothesline, this method works well, and makes it easy to release the cord end for wrapping around a plant stem and then threading back through the aperture 16.

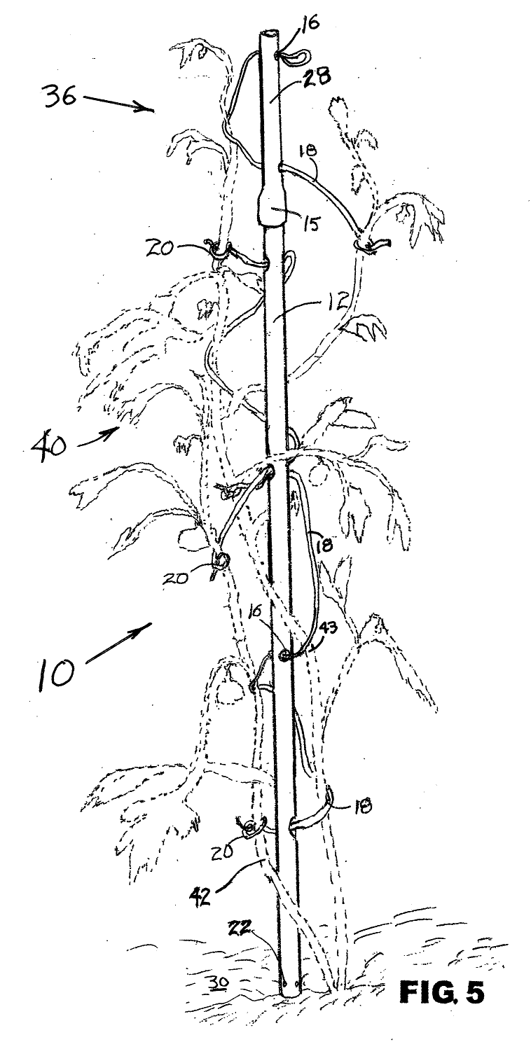

FIG. 5 illustrates the use of the present invention with a plant 40, typically a tomato plant. The plant support apparatus 10 is driven into the ground 30 about 9 to 12 inches deep with a hammer or the like adjacent to where the plant 40 emanates from the ground 30. The two ends of one cord tie 18 have been threaded through an aperture 16, or pair thereof, then tied to a plant stem or branch 42 with a single knot 20. This technique works well for supporting branches relatively far from the plant stake if the cord tie 18 is at least as long as specified herein. In other places, the cord 18 wraps around the plant stem or branches 43 and many support points are thereby provided. Unlike many other products on the market, this support pole can be installed at any stage of the plant growth and works equally well on sloped or flat ground. As the plant grows, it will be necessary to occasionally use the tie cords 18 higher on the pole 12, and perhaps reposition and retie some of the other cord ties 18. If and when the plant reaches the top of the pole 12, the optional extension member 36 may be added by slipping the coupling means 15 on the extension tube 28 over the top of the pole 12. In this figure, the coupling means 15 is a flared end on the extension tube 28, but other means are illustrated in FIGS. 8 and 9.

FIG. 6 provides a partial perspective elevation view of an alternative embodiment of the present invention with the cord ties arranged for storage, transport, or display for sale. FIG. 7 provides a detail elevation perspective view of the same. The cord ties 18 are wrapped in a tight spiral 50 around a portion of the tubular pole 12. One end of the cord tie 18 is threaded through two wall apertures 16 and tied in a single knot 20 to prevent it from slipping out. After the cord tie 18 is wound tightly around the pole 12, the distal end of the cord tie opposite the knot end is tucked into the cord retention aperture 23 until it is tightly in place. The cord ties are preferably made of flexible polyvinyl chloride, what is commonly sold as clothesline, for example a 5/32-inch extruded PVC clothesline sold by Ace Hardware. Accordingly, the cord retention aperture needs to be a minimum of 0.16 inches at the narrowest dimension. When the cord tie 18 is needed, the end tucked into the aperture 23, or the knot 20 at the other end, is released and the cord unwound for use.

FIG. 8 provides a partial elevation perspective view of an alternative coupling means for the extension member 28 on top of the elongated pole 12. A female slip-fit joint 17 may optionally be glued to one of the vertical members, but the extension tube 28 is removable from the elongated pole 12. FIG. 9 provides a partial elevation perspective view of another alternative coupling means for the extension member. In this case, the lower elongated pole 12 has a flared end 19 which has an inside diameter slightly larger than the outside diameter of the flared end 21 on the extension tube 28. This creates a secure but easily separated coupling of the two elongated tubes. In this case, the upper extension tube 28 has a smaller diameter than the lower elongated pole 12. Cord ties 18 and 24 can be threaded through apertures 16 in either tube portion.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. A plant support apparatus comprising:
a) an elongated substantially rigid pole having a first predetermined length;
b) a plurality of apertures of a predetermined size spread axially along at least half of said first predetermined length of said elongated pole;
c) at least two flexible cord ties of a preselected material and having a second predetermined length threaded through at least three of said apertures in a wall of said elongated pole; and
d) a tapered end of said elongated pole shaped substantially to a point.

2. The plant support apparatus, according to claim 1, wherein said first predetermined length is between about 5 and 7 feet.

3. The plant support apparatus, according to claim 1, wherein said second predetermined length is between about 15 and 60 inches.

4. The plant support apparatus, according to claim 1, wherein said predetermined size of said apertures is at least 0.16 inch at a narrowest dimension.

5. The plant support apparatus, according to claim 1, wherein said preselected material of said cord ties is a flexible polyvinyl chloride (PVC).

6. The plant support apparatus, according to claim 1, wherein said apertures are radial.

7. A plant support apparatus comprising:
a) a first elongated substantially hollow and substantially rigid tube having a first predetermined length;
b) a plurality of apertures of a predetermined size spread axially along at least half of said first predetermined length;
c) at least two flexible cords of a second predetermined length threaded through at least three of said apertures in a wall of said first elongated tube;
d) a tapered end of said first elongated tube shaped substantially to a point; and
e) an extension member including:
(i) a second elongated substantially hollow and substantially rigid tube having a third predetermined length;
(ii) a plurality of apertures of a predetermined size spread axially along at least half of said third predetermined length of said second elongated tube;
(iii) at least one flexible cord of a fourth predetermined length laced through at least two of said apertures in a wall of said elongated tube; and
(iv) a preselected coupling means disposed at an end of one of said elongated tubes for removably connecting said elongated tubes along the same axis.

8. The plant support apparatus, according to claim 8, wherein said third predetermined length is between about 30 and 60 inches.

9. The plant support apparatus, according to claim 8, wherein said fourth predetermined length is between about 18 and 60 inches.

10. The plant support apparatus, according to claim 8, wherein said first predetermined length is between about 3 and 7 feet.

11. The plant support apparatus, according to claim 8, wherein said preselected tube coupling means is a flared end on one of said elongated tubes mating with an end on other elongated tube.

12. The plant support apparatus, according to claim 8, wherein said preselected tube connection means is a slip-fit coupling on one of said elongated tubes mating with an end on other said elongated tube.

13. The plant support apparatus, according to claim 8, wherein said apertures are radial.

14. A method of supporting plants growing up from soil comprising:
a) providing a support apparatus including 1) an elongated substantially hollow and substantially rigid tube having a first predetermined length; 2) a plurality of substantially radial apertures spread axially along at least half of said first predetermined length; 3) at least two flexible cords of a second predetermined length threaded through at least three of said radial apertures in a wall of said tube; 4) a tapered end of said tube member shaped substantially to a point; and 5) an extension member with a removable coupling means mating to a top of said elongated tube.
b) forcing said elongated rigid tube into said ground-level soil adjacent a plant to be supported.
c) extending a first end of one of said flexible cords through two opposing said apertures;
d) tying extended said first end to a branch portion of said plant;
e) looping a portion of said flexible cord around a portion of said plant;
f) threading a second end of said one flexible cord through another pair of said apertures at a different height along said elongated pole;
g) repeating steps c-f with a second of said flexible cords;
h) joining said extension member to a top of said elongated rigid tube with said coupling means;
i) waiting until plant to be supported grows near top of the said elongated pole; and
j) repeating steps c-f with the flexible cord which is part of the extension member.
